(19) United States
(12) Patent Application Publication
(10) Pub. No.: US 2009/0198511 A1
(43) Pub. Date: Aug. 6, 2009

(54) Methods and Systems for Collecting and Analyzing Medical Data

(76) Inventor: Raimar Boehlke, Murnau (DE)

Correspondence Address: IP STRATEGIES, 12 1/2 WALL STREET, SUITE E, ASHEVILLE, NC, 28801, US

(21) Appl. No.: 12/025,154

(22) Filed: Feb. 4, 2008

(51) Int. Cl. G06Q 50/00

(52) U.S. Cl. 705/2

(57) ABSTRACT

The invention provides methods and apparatus, including computer program products, for processing medical data of a database, the medical data relating to diseases, and symptoms related to the diseases, said method including, Requesting an individual user to input data descriptive of a symptom; searching the database for data descriptive of diseases related to the inputted data descriptive of the symptom; generating a report listing diseases which are related to the inputted data descriptive of the symptom; associating a frequency indication to the each of the listed diseases, the frequency indication being representative of the frequency of reported associations of the respective listed disease; outputting the report with the frequency indication associated with each of the listed diseases.

### BACKGROUND OF THE INVENTION

The present invention relates generally to the processing of medical data. More specifically, the invention relates to the collection and analysis of large amounts of patient medical data to generate a large medical data pool comprising data descriptive for symptoms, diseases, medical treatments, and relations there between, as well as processing tools needed.

### STATE OF THE ART

A weakness of our modem medical system is proper diagnosis and the lack of tailored therapy provision in a multivariate disciplinary environment. The standard of care varies dramatically by location, education, financial support, diagnosis equipment and the availability of a multi disciplinary expert team. Especially for diseases that cannot be test verified, like many viral or bacterial diseases, there is typically a lack of comparative data sets to allow for proper diagnosis and tailored therapy. Physicians are diagnosing and treating based on experience and/or based on large clinical studies that have been carried out by pharmacological institutions or large public health carriers. As consequence patients are receiving generic products often even without particular diagnosis and consideration of individual factors (epidemiological data). In many cases their patient outcome remains suboptimal at best.

Physicians agree upon the value of epidemiological studies as they reflect a holistic view. In daily practice though it is a major undertaking to apply and fund epidemiological studies as they are strictly supervised by regulatory bodies. For that reason many aspects of human health remain undiscovered, not outspoken or at assumption level.

### SUMMARY OF THE INVENTION

It is an object of the present invention to provide methods and systems for collecting medical data which allow for generating a large medical data pool comprising symptoms, diseases, medical treatments, adverse events, generally speaking disease and epidemiological profiles and relations there between. The system to be provided should deliver correlations in health treatment that justify the inception of large clinical trials.

In general this invention provides methods and apparatus, including computer program products, for processing medical data of a database, the medical data relating to diseases, and symptoms related to the diseases, said method including:
A) Requesting an individual user to input data descriptive of a symptom;
B) Searching the database for data descriptive of diseases related to the inputted data descriptive of the symptom;
C) Generating a report listing diseases which are related to the inputted data descriptive of the symptom;
D) Associating a frequency indication to the each of the listed diseases, the frequency indication being representative of the frequency of reported associations of the respective listed disease;
E) Outputting the report with the frequency indication associated with each of the listed diseases.

In a further embodiment, the invention relates to a computer-implemented method of collecting medical data for a database, the medical data relating to symptoms, diseases, and treatments of individual users with respect to diseases, said method including:
A) Requesting an individual user to input data descriptive of symptoms of a disease;
B) Requesting individual user to input data descriptive of a diagnosis made by a medical professional with respect to the symptoms and the individual user;
C) Requesting individual user to input data descriptive of a treatment received by the individual user with respect to the symptoms and the diagnosis;
D) Requesting individual user to input data descriptive of symptoms and diagnosed disease which has been successfully treated;
E) Requesting individual user to input data descriptive of symptoms and diagnosed disease which has not been successfully treated;
F) Requesting input of qualification of the treatment received;
G) storing the inputted data;
H) Requesting individual user to input data descriptive of resources for the treatment received, the resources comprising at least one of:
   quantities of treatment;
   cost of treatment;
   time of treatment; and
   human resource factor

Yet further, the invention comprises a computer-implemented method of collecting medical data for a database, the medical data relating to diseases, symptoms and treatments of individual users, said method including:
A) Requesting individual user to input attribute data for an individual user, the attribute data being data which is constant during lifetime of the individual user; attribute data comprising at least one of
   date of birth;
   blood group;
   genetic code;
   indications as to ethnic background;
   indications as to hereditary diseases;
B) Requesting individual user to input variable data for an individual user, the variable data being data which is subject to changes during lifetime of the individual user; variable data comprising at least one of
   body mass index;
   indications as to geographic location;
   indications as to environment;
   indications as to risks;
C) Associating the inputted data with the individual user;
D) Storing the inputted data associated with the individual user in the database.

Still further, the invention comprises a computer-implemented method of collecting medical data for a database, the medical data relating to diseases, symptoms and treatments of individual users, said method including:
A) Displaying, to an individual user, text fields comprising data descriptive of predefined symptoms of predetermined diseases;
B) Prompting the individual user to select one of the text fields;
C) If the individual user does not select any of the text fields, prompting the individual user to enter the data descriptive of the particular symptom in a free text field;
D) Performing a search in the database for data similar to the data inputted in the free text field;
E) If data similar to the inputted data is found in the database, discarding the inputted data;
F) If data similar to the inputted data is not found in the database, initiating an evaluation process of the inputted data.

In particular, the invention comprises also computer systems for performing the inventive methods.

Furthermore, the invention comprises computer-readable storage media comprising program code for performing the inventive methods, when loaded into a computer system.

One of the advantages is that the present invention provides a method for capturing data of a specific group of objects, individuals, animals, bacteria, trends, emotions/information, and the like which describe them in their environment, and their behavior upon changes in their environment of intrinsic or external nature. The value for the user is created by not only referring to a scientific approach or a calculation model, but generating the data pool from real profiles, thus containing experience and information upon success rates, adverse events together with soft factors like quality of life statements. Specificity increases direct proportional with the number of profiles saved in the system or the category.

A large set of tools is provided by the system to process and benefit from the database. Even hypothetical calculations can be performed. All set values from the database may be processed in retrospective, meaning data occurred in the past is drawn into conclusion as well as current facts.

User generated data is used for endlessly ongoing studies (study character is familiar to epidemiological studies) and reflects de facto profiles. No formal participation in clinical trials is required.

Particularly interesting are data points that are untypical and reflect an exception to the rule as those findings may lead to a closer look to alternative active agents, new applications for established agents, quality of life improvements or innovative study designs. Thus a tool for front end research work is created by the inventive system database approach. This approach theoretically supports any detail level required to help any user to receive or post comparable data sets for symptoms or diseases that need to be treated.

The invention can be applied to the health care sector (find treatment options), in market research (trend finder) and threat tracking (epidemic, criminals).

The inventive system is dynamic, and reports can be updated in a routine, in an online session or from mobile devices like a cellular phone.

In order to guarantee and maintain high quality level of the data and reports generated, various tools for qualification and verification of contents are provided. In the medical application for instance there are drop-down, multiple choice and Ajax supported menus and check boxes that contain the main symptoms and treatments already approved through a prior process. Any content in the select fields must run through the process of qualifying and verifying contents. Any user can make content proposals (e.g. new therapy); this content proposal has to pass a predefined qualification process as well.

The medical application deals with gathering symptoms, chronological course of disease and epidemiological data. After entering data the user has the chance to research factors of his disease (symptoms, therapies, active agents), associate the presence of his disease with his way of living (epidemiological background) and optimize his treatment options considering both impacting fields. This happens on basis of all available comparable datasets of the database.

The system presented gathers information from the end user and should therefore remain unbiased. Second favoring factor for the end user is the peer character. Many people trust the opinion of peers more than scientific studies that have been supported by large lobby groups. In comparison to a regular patient forum or blog the invention offers data assortment, correlation and statistical tools to consolidate and process more than only one opinion.

The present invention may lead to a system that starts out as collection of experience reports of individual users but develops into a dynamically structured, quality supervised database structure that carries the potential to reveal scientific hints for new findings in the medical treatment.

Further, the present invention may be used for tracking, differentiating, qualifying and quantifying changes and their backlashes to or from an individual/animal/bacteria/trend by generating a structured data pool and providing tools to benefit said data structure through provision of filter applications.

The invention provides a set of predefined tools (e.g., filter applications, optimization tools); chronology/time reference tools, like time print or duration tools; manual filter applications for any of the profile structure database bricks; research tools for pharmacological- and medical device industry; resource tracking tools for health carriers; effective agent research tools.

Such tools may be provided via internet, or on portable devices like cell phones.

The inventive method provides understanding of regulating mechanisms and equations that allow for completion or extrapolation of behavioral patterns of individuals/animals/bacteria/trends with similar profile structures. Tools are provided for trend-, epidemic-, threat-research and tracking to the extent of assessing probability of occurrence levels. The method may be based on real user profiles.

### BRIEF DESCRIPTION OF DRAWINGS

FIGS. 1 to 3 illustrate the process flow of establishing new content in the database;

FIG. 4 illustrates the “Open User Database” process according to a first embodiment of the present invention;

FIG. 5 illustrates the use case “Search Disease”;

FIG. 6 illustrates the use case “Search Matching Disease Profiles”;

FIG. 7 illustrates the sub-use case “Enter Course of Disease”;

FIG. 8 illustrates the use case “Search Matching Epidemiological Profiles”;

FIG. 9 illustrates the sub-use case “Enter Epidemiological Data”;

FIG. 10 illustrates use case “Optimize Treatment Options”;

FIG. 11 illustrates branching options; and

FIG. 12 illustrates a preferential business process using the described embodiments.

### DETAILED DESCRIPTION

The following notation will be used in the detailed description.
“Function” is an action, function, process, activity.
“SD”=Search Disease;
“ECOD”=Enter Course of Disease;
“EEPI”=Enter Epidemiological Data;
“COD Profile”=Course of Disease Profile;
“EPI Profile”=Epidemiological Profile;
“SMDP”=Search Matching Disease Profile;
“SMEP”=Search Matching Epidemiological Profile;
“OTO”=Optimize Treatment Options.

[Business Process “Content Proposal”]

Establishing new content in the database is a key functionality of the system since this ensures that the database grows dynamically, into detail level and is reflecting state of the art treatment options almost in real time as well as in retrospective. The system has two options to associate and refer to chronological order. First option is reference to the calendar (e.g., May 15 symptom headaches occurred first). Secondly time may be managed in relative terms through operation with durations (e.g., user was treated with ascorbic acid for two weeks). As mentioned above, a main feature of the invention is that the database can be fed with data by the community of users. Thus, should a user not find the intended content in the application, he will be encouraged to propose an addition in form of new content that will be offered as checkbox after verification. This way, the database can continuously grow or be kept updated.

Finally, the user is interested in qualified and verified data. Truthful reports can only be generated from database content that is correct, associated appropriately and processed with a logic that has previously been verified in test runs. Therefore, the authenticity and quality of the data stored in the database is an important aspect of the present invention.

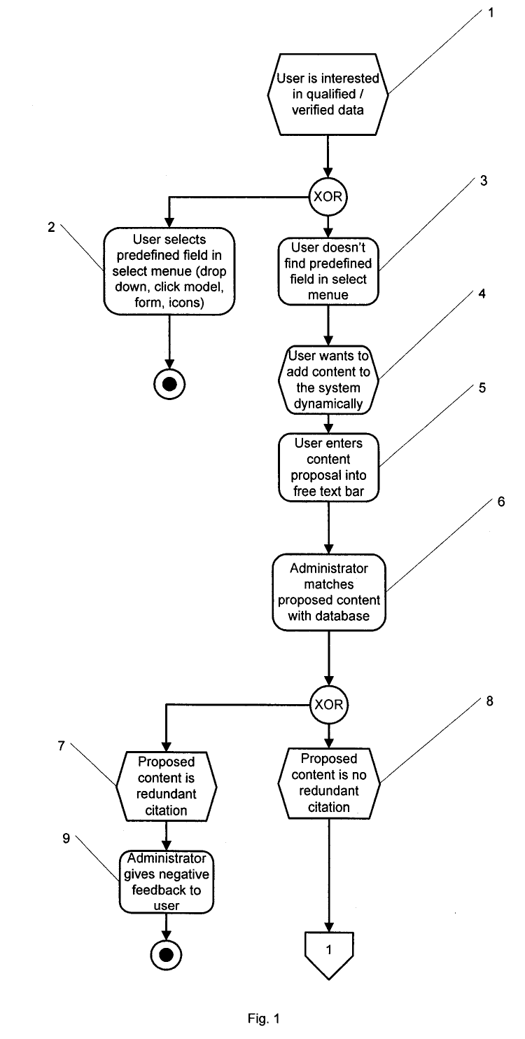

FIGS. 1 to 3 illustrate the process flow of establishing new content in the database by a user of the community according to the first embodiment of the invention. This process provides for qualification of new content, and describes the process of verifying content proposals that are being done by any user in any check box of the future.

The process flow begins with case 1 of FIG. 1 where the user may want to retrieve data from the database (e.g., symptoms: headache, neck pain, and tinnitus). It is standard to the system that only previously qualified content can be checked (step 2). On the other hand, if the user does not find such data in a predefined field in the select menu of the retrieval screen (step 3), i.e., the user cannot find the symptom that applies to his state in the drop down, multiple choice or checkbox menu of the application, he is prompted by the system to make a new content proposal. In the following, it is assumed that the term “sleeplessness” is entered as the new content proposal.

Thus, if the user enters his new content proposal, as soon as the new content proposal is sent to the administrator, the Content Proposal Process gets started, case 4.

In step 5, the user enters the content proposal into a free text bar provided by the system, e.g., the term “sleeplessness”.

In step 6, the database administrator matches the new content proposal with the content of the database, in order to avoid redundant content and accordingly affect the quality of the reports generated by the system. Hereto, the system uses an algorithm and a matrix (computerized or interactive method) that screens the database for similar content. If it turns out that the proposed content is a redundant citation, case 7, the administrator gives in step 9 negative feedback to the user, and the process ends here.

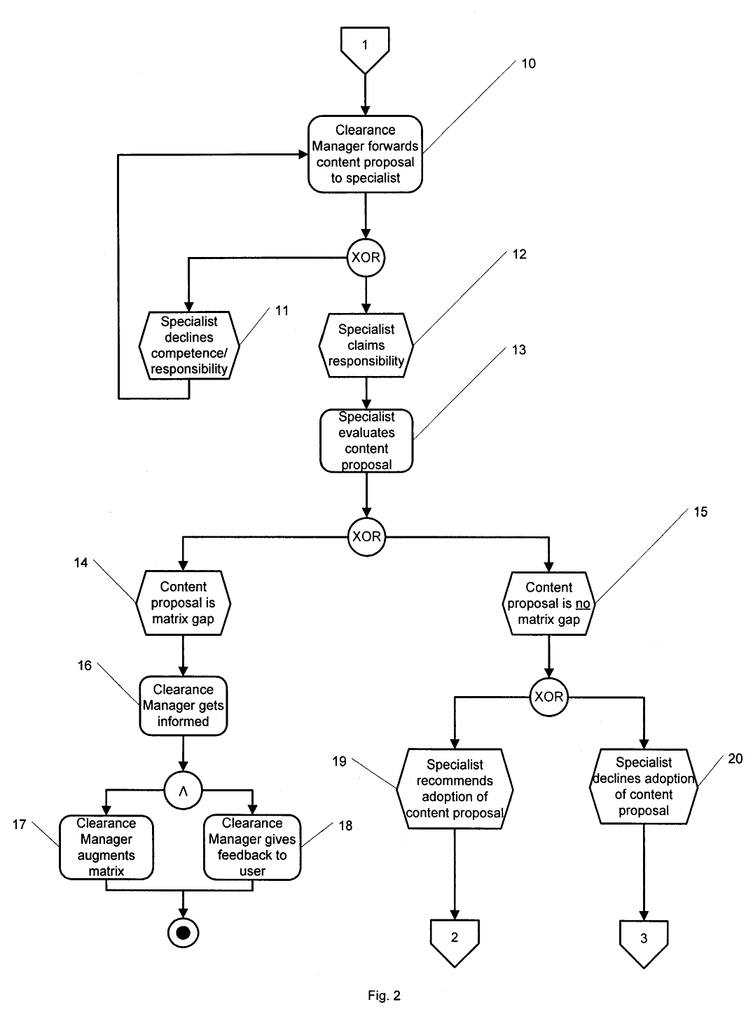

Otherwise if it turns out that the new content proposal is no redundant citation, case 8, the system asserts that the user has possibly proposed valuable “new” content, and the system proceeds with forwarding the new content proposal to a clearance manager, see FIG. 2, step 10.

The clearance manger is now responsible for administering the clearance process of content proposals and communicates with the specialist community that consults the system. Such specialists can be: Physicians, pharmaceutical experts, naturopathic experts, physical or mental therapists and the like. The clearance manager forwards the proposal to whatever specialist he thinks is competent for the new content proposal of the user, step 10.

If the specialist claims responsibility, i.e., the specialist that has received the proposal through the clearance manager agrees to be the right person for the request, he will evaluate the new content proposal, case 12. Otherwise, if the specialist declines competence, i.e., he does not feel he could contribute valuable arguments for or against this content proposal, case 11, he pushes the proposal back to the clearance manager who will address a different consultant. Then the process returns back to step 10. The steps of this loop are repeated until an expert is found who claims responsibility.

The competent expert evaluates the new content proposal in step 13. There are two possible outcomes. First, the content proposal is no matrix gap, case 15. That means the proposed content is not redundant. In this case, the process of verification will continue with step 19 or 20.

Explanation of matrix gap: A user might have typed in “long sound in the ear” instead of “continuous peep in the ear” or “tinnitus”. The term “long sound in the ear” would be new to the system, thus not yet a redundancy as of our definition, but it is still a different expression for the same symptom; the inventive system would add the “long sound in the ear” to the matrix for future reduction of response time to the user. This is part of the dynamic characteristics of the database.

Second, if the new content proposal is a matrix gap, it will be declined by the system, case 14. An example of a matrix gap is if the content proposal “long sound in the ear” describes a symptom known to the system merely in different words. In this case, the specialist informs the clearance manager about the matrix gap, see step 16, and steps 17 and 18 are executed. In these steps, the clearance manager augments the matrix, and gives feedback to the user. This way, the matrix is growing dynamically. The user who made the new content proposal gets feedback that he called his symptom differently than other users before him. The process ends at that point.

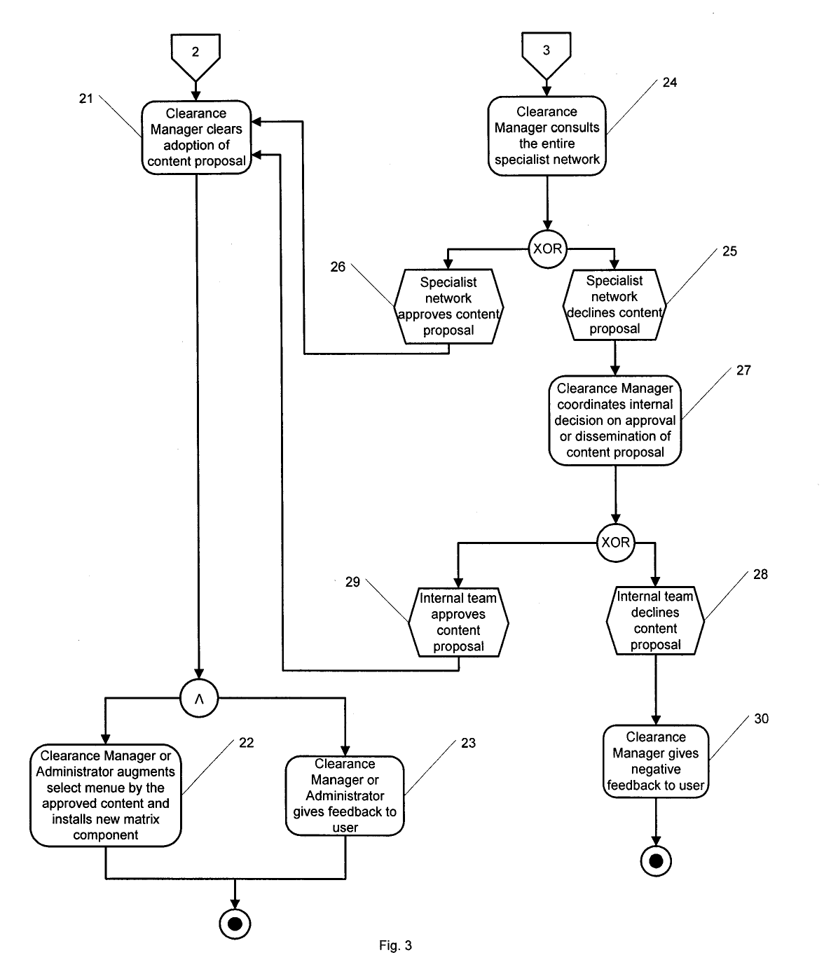

On the other hand, if in case 19 of the verification process the specialist recommends adoption of the new content proposal, the process flow proceeds with step 21 in which the clearance manager clears adoption of content proposal. In this case, steps 22 and 23 of FIG. 3 are executed. In step 22, the clearance manager (or he database administrator) augments the select menu by the approved new content, and installs a new matrix component, e.g. heartburn that can from now on collect redundant names like GERD or Reflux Disease.

In step 23, the clearance manager or administrator gives positive feedback to the user that the content proposal has been approved. This is the successful end of the process “Enter new content proposal into the database”.

Then, the user will get the opportunity to enter the data relating to the accepted new content proposal. To that end, the program flow proceeds with the sub-use case “Enter Course of Disease” to be described later.

On the other hand, if in case 20 the competent specialist declines adoption of content proposal the process flow proceeds with step 24 of FIG. 3, where the clearance manager will consult the entire network of specialists. A specialist may decline a content proposal for various reasons like: not relevant, trash, wrong context, or scientifically wrong.

Step 24 of consulting the entire specialist network is performed for double checking whether all specialists think the proposal should really be discarded. If the specialist network approves content proposal, case 26, or the entire network at least tends to approve the proposal, case 29, the process flow will proceed with step 21 described above.

If, on the other hand, the specialist network in case 25 declines the new content proposal again, that is to say none of the specialists have approved to the new content proposal, the clearance manager coordinates in step 27 a final internal decision on approval or dissemination of content proposal. As last instance of the decision process on whether the proposal gets approved or declined stands the internal gate, if the portal provider thinks it might be beneficial to approve and can exclude damage to the database and reporting tools, he can approve the proposal against the recommendation of the expert team. In this case, the process flow goes to step 21 described above. Otherwise if there is no approval by the internal team, case 28, the clearance manager gives negative feedback to the user who made the proposal in step 30, and the process ends without new data being entered into the database.

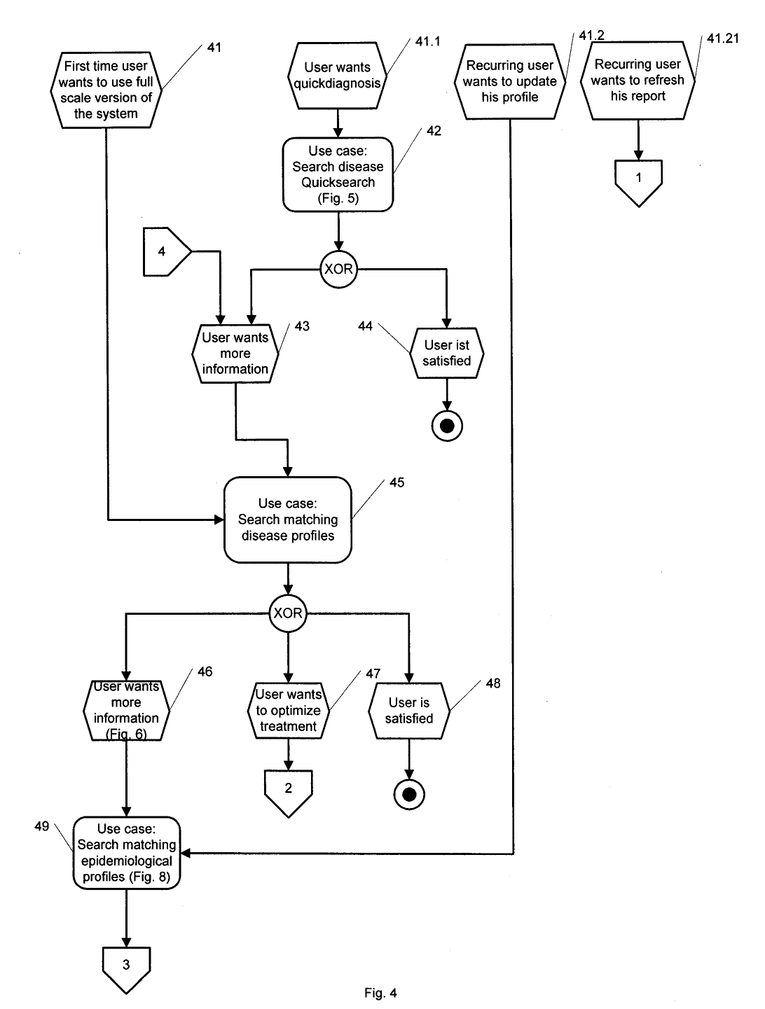

FIG. 4 illustrates the process of opening the user database according to the second embodiment of the invention.

A user which is not familiar with the system may, as an exemplary usage of the inventive system, use a quicksearch tool for running a disease likelihood report that is generated from the user database after the user entered his symptoms, this is case 41.1 of FIG. 4.

The first time user who might be educated by peers already or who trusts the system for some reasons might enter the registration area right away and take advantage of the full scale version of the system immediately, refer to case 41 of FIG. 4. Then, the user comes to the registration area right away.

A recurring user might come back to update his profile, as referred to in case 41.2 of FIG. 4.

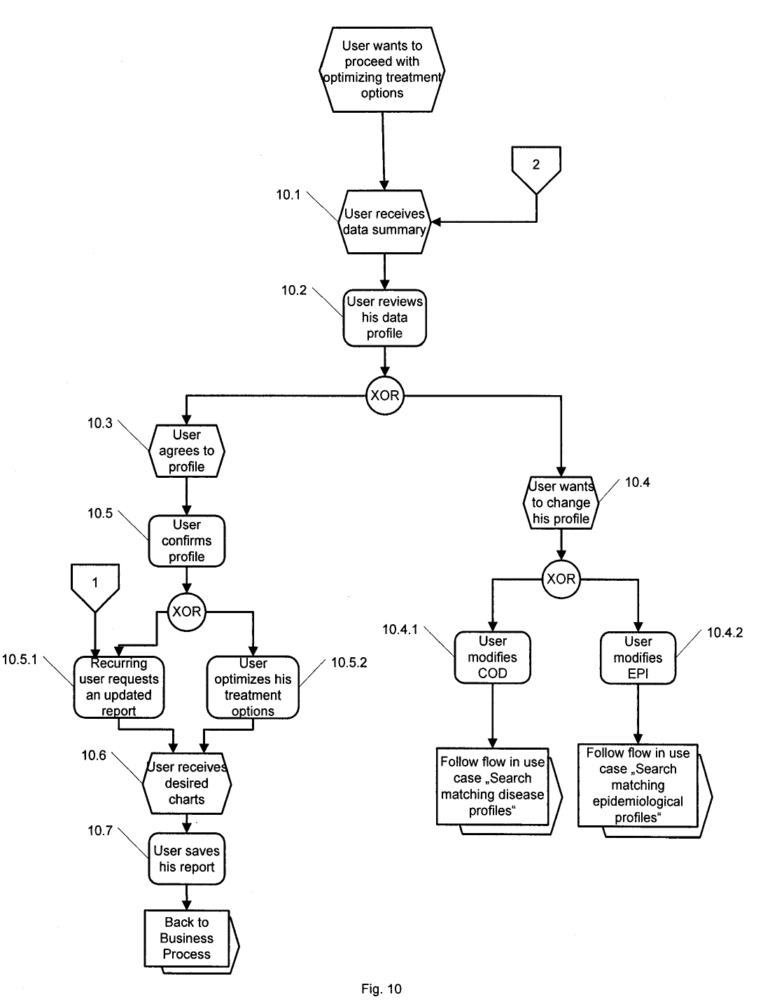

Yet another user might come back to the system and update his report, hoping that additional profiles entered between now and his last online session have improved the information available in his personalized report, as referred to in step 41.21 of FIG. 4. The user may then come via interface 1 to the process flow described below in connection with FIG. 10.

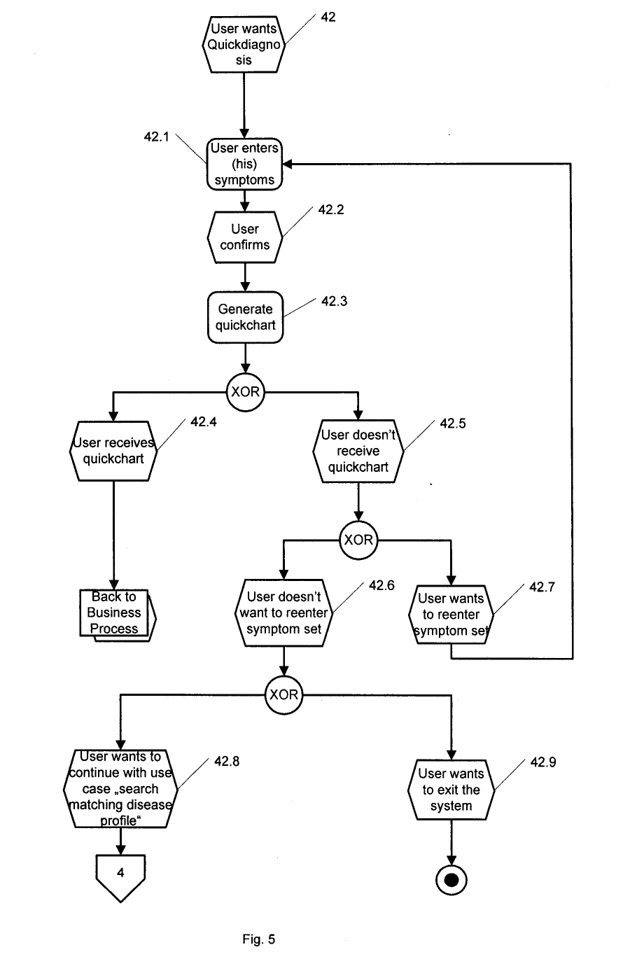

The system takes profit of the comparison of real user profiles and user disease histories; accordingly, the differentiating factor to the established health web sites is the absence of theoretical approaches for diagnosis; this tool “Search Disease” (box 42) does not require registration of the user; consequently data of users that work in this area only will not be saved to the database as an agreement has not been signed yet, see the process flow described in connection with FIG. 5 for details; the second way to use the inventive system is to directly enter the registration area and thereafter take full advantage of the system's offerings; the second pathway is being initiated if the user wants to get more information, case 43, by entering “Search Matching Disease Profiles”, step 45, and/or “Search Matching Epidemiological Profiles” (step 49). On the other hand, the process may exit, case 44, if the user is already satisfied with the results obtained so far.

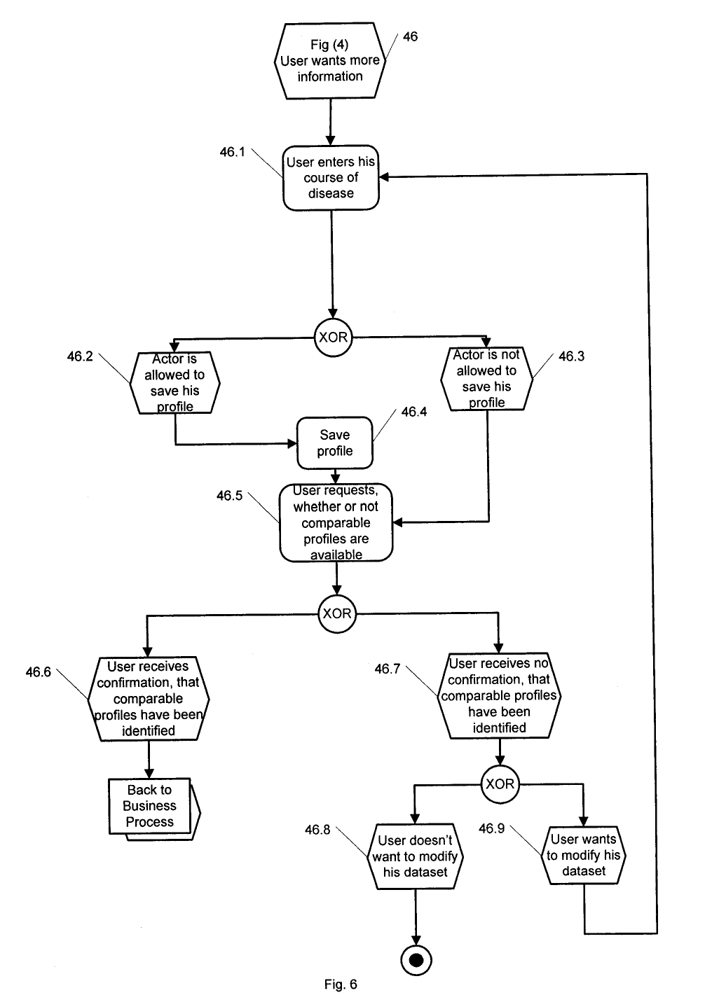

At this point, the process flow may branch into three paths. Should the user wish to retrieve more information on disease profiles, the process flow enters into the use case SMEP, case 46, which will be described in detail below in connection with FIG. 6. Should the user wish to optimize his treatment, the process flow enters into the use case Optimize Treatment Options, case 47, which will be described in detail below in connection with FIG. 10.

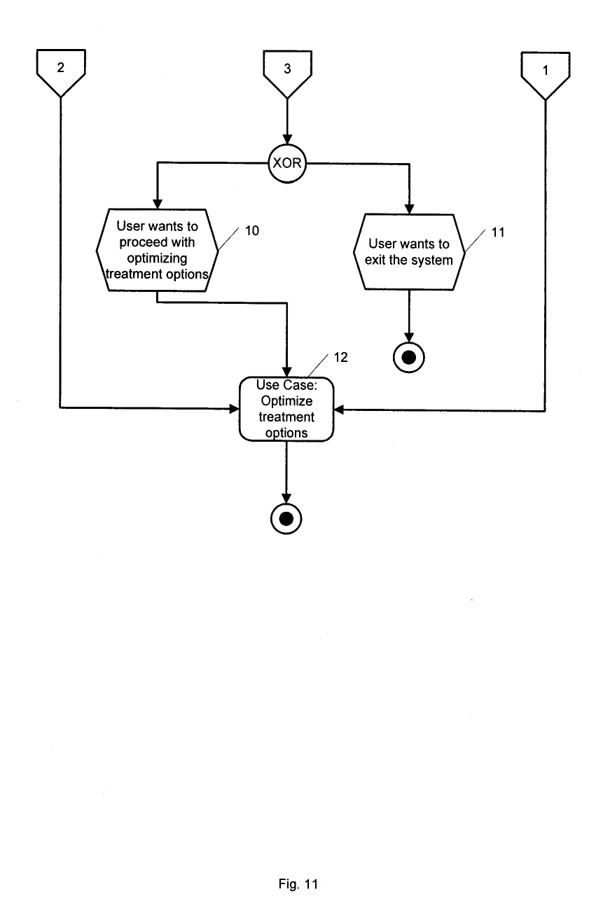

Continuing on from use case SMEP the user may proceed with OTO options as described in FIG. 11, via interface 3.

Finally, if the user is already satisfied at that point, case 48, the process ends here.

With respect to FIG. 5, the program flow for the use case “Search Disease” (quicksearch) is described. In step 42.1, the user enters his symptoms into an array. If in case 42.2, the user agrees with the symptom array that he entered, a quickchart based on that will be generated. In step 42.3, the user requests “quickchart” by clicking a quickchart icon; the system will generate a report that lists all relevant diseases that have been reported in the database; the system differentiates between diseases that have been test verified and ones that are only assumed; the chart will display likely diseases in percent bars and stagger from most to least frequent citation; in case of two and more symptoms entered the system will release n+Σ(n−1) charts while adding all terms from nmn to n=0 in the (n−1) part; n being a natural number; the one with the highest specificity is the full match chart (all entered symptoms do match with reported database cases); subsequently the next charts go down to lower number of matches; finally all individual symptoms are associated with the diseases saved in the database; the user will find it easy to focus on the symptoms that seem most important to him because any inter-combination is displayed; on the other hand the user might detect correlations with symptoms mentioned that he would not have expected. In case 42.4, the user gets the desired report. i.e., the quickchart, and can now decide whether he wants to proceed using the database approach to learn more about how he might optimize his treatment options, which will reflect the main application. Returning to case 43 (FIG. 4), the user may want to continue and take full advantage of the systems offerings.

On the other hand, if the user does not receive the quickchart, case 42.5, the user may reenter the symptom set, case 42.7, then the process flow loops back to step 42.1 described above, or the user may not want to re-enter symptom set, case 42.6, then the user may want to search matching disease profiles, step 42.8, and the process flow continues with the use case SMDP described below, or the user may want to exit the system, case 42.9.

[Use Case “Search Matching Disease Profiles” (SMDP)]

In this use case, the user enters his course of disease, see step 46.1 in FIG. 6. Refer also to sub-use case “Enter Course of Disease” which will be described in the next paragraph. First, the system makes a decision as to whether the user is allowed to save his profile. If so, the system proceeds with case 46.2 where the system offers two main applications: The standard application targets any individual user who will agree to save his profile in the terms and conditions of the system; value and relevance is continuously growing by this procedure the second standard user is the medical professional account that allows for full usage of the database except that no patient data will be saved to the database; by this means medical professionals like doctors can benefit the system without having to worry about consent agreement, privacy rights and ethics commission requirements; in any case, the system output should only be consulted for inspiring subsequent lab test or professional diagnosis tools. In step 46.4, the user saves his profile to the database. If the user is not allowed to save his profile, step 46.4 is by-passed (case 46.3). In step 46.5, the user may request whether or not comparable profiles are available. This is a press button action required by the user; a special algorithm will then process the database contents and search for comparable datasets; the output of the search is a simple confirmation (qualitative and/or quantitative charts are feasible) that datasets for comparison have been identified; at this point it is very likely that matches are found because any overlap in the reference individual/group has to be considered.

If the user receives confirmation that comparable (quality and quantity) datasets have been identified, case 46.6 (FIG. 6), the program flow continues with the process of the use case SMEP.

Otherwise if the user receives confirmation that no comparable profiles have been identified, case 46.7, the user gets in the opportunity to modify or complete his dataset in order to further specify his profile and increase the chance of finding an appropriate dataset to compare with, case 46.9. The system leaves it to the discretion of the user on how deep of a level his dataset will be filled out. It is attributing to the system that detail level input might deliver detail level output. All output values are genuine from dataset comparison; accordingly there cannot be any detail level output without entering same level of detail beforehand. If the user does not want to modify the data set, case 46.8, the process ends at this point.

[Sub-Use Case Enter Course of Disease ECOD)]

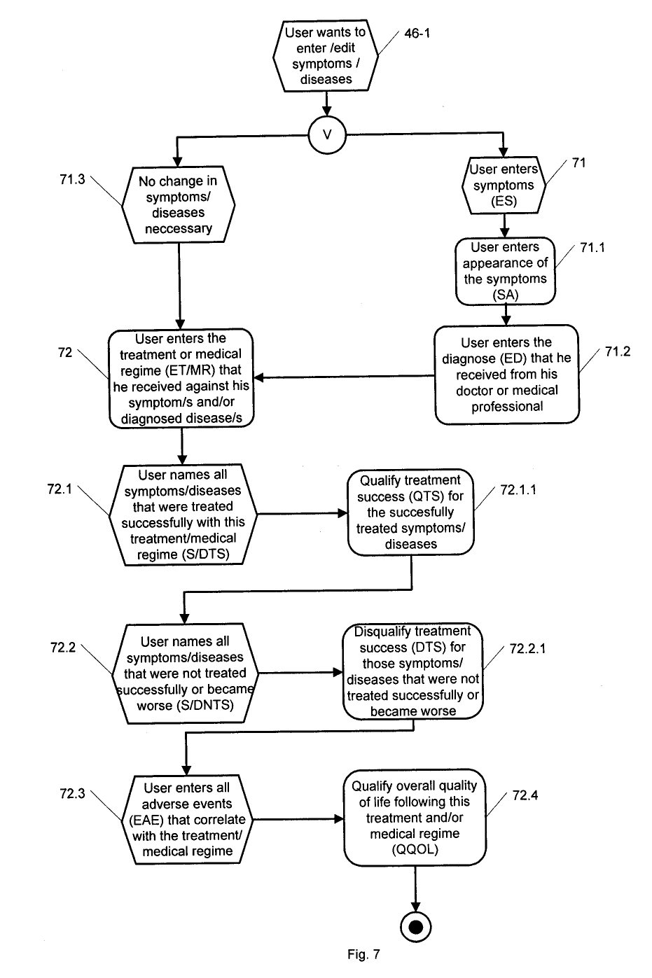

In the following, the sub use case ECOD is described with reference to FIG. 7, where the user gets the opportunity to enter his symptoms and all relevant information concerning his course of disease.

Prior to actually entering or updating the symptoms, the user will be asked, in step 46-1, whether he wants to edit, complete or change is symptom list. That is necessary because at this point it is not clear where the user comes from, i.e., whether he is a recurring user, a first time user, a user coming from “Search Disease” (SD), or a user entering the ECOD level right away. An explanation will be presented for this entering field: for the inventive system all symptoms and/or diseases are relevant, meaning symptoms, diseases, morbidities, co-morbidities, disease criteria/characteristics/attributes, attendant symptoms, adverse events, generally all symptoms and morbidities related to body, mind and soul. The user will be asked to enter all of his symptoms even if he does not think they would be related to each other, step 71. In sub-step 71.1, the user is prompted to enter the appearance of the symptom (SA). For that, a part of the field “enter symptoms” is the association with an appearance. For instance, one user might associate his headache with driving at night or consumption of chocolate. This database approach is going to allow an algorithm for finding reasons for a disease or symptom for individuals (e.g., allergies).

In sub-step 71.2, the user is prompted to enter the diagnose he has received from his doctor or medical professional—if applicable. However, it is a helpful feature of the inventive system that the diagnosis entered by the user is not taken for granted; e.g., a patient diagnosed with MS (multiple sclerosis) will not be saved directly as MS patient. That way, false external diagnosis can be excluded, and the patient has the chance to find hints for his real underlying disease. Nevertheless there will be patient pools like e.g. colon cancer patients; for participation in a patient pool it is required though that a lab test has been carried out to verify the existence of the disease.

The user may come from step 46-1 directly to step 72, bypassing steps 71, 71.1, 71.2, if there are no changes in symptoms or diseases necessary (step 71.3).

In step 72, the user is prompted to enter the treatment or medical regime that he received against his symptom/s and/or diagnosed disease. In the mask to be opened, the user is asked to enter all treatments he received, one by one. Per treatment the user will have to enter the whole chain of events (see the following steps). If the user received multiple treatments at a time (e.g., medical regime and physiotherapy) he is asked to link those treatments together, so the database can link those therapies as well, and distinguish between stand alone and multiple approach therapy. Moreover, the user will be asked to chronologically order the therapies he received; that way even therapies in the past can augment the information pool and complement the picture of the individual health state. A time reference system may include a time print on the calendar as well as an approach of managing the database points on basis of durations, depending on the grade, accuracy or relevance requirement of the information needed or included to the system. A flue tracking tool will probably be oriented on the calendar based time reference method as it is supposed to reveal current threats like dispersion time.

In step 72.1, the user is prompted to name all symptoms/diseases that were treated successfully with this treatment/medical regime. This field is—as stated above—seen in relation to the therapy and/or medical regime that has been entered previously. Accordingly, the logical association is given between treatment and treatment success. Later this is one basic tool for the user to research best treatment success.

In the following sub-step 72.1.1, the user is prompted to qualify the treatment success for the successfully treated symptoms/diseases; the user will have the chance to qualify the treatment success by voting from 1 to 9 with 9 being very good treatment success and 1 being very poor treatment success. The vote is a key for a later tool named “Find Best Treatment Success”.

In step 72.2, the user is prompted to name all symptoms/diseases that were not treated successfully or became worse. This part of the database will provide data points for the tool find treatment with the worst patient outcome.

In sub-step 72.2.1, the user is prompted to disqualify treatment success for those symptoms that were not treated successfully or became worse; the disqualifying process works like the qualifying process with rates from 1 to 9 (9 being very inappropriate and 1 being not recommended).

In step 72.3, the user is prompted to enter all adverse events that correlate with this treatment/medical regime. Adverse events are symptoms or diseases that are caused by the treatment or medical regime itself. With severe diseases, that is a common problem because the active agents need to be rather aggressive to be effective, as for instance agents for end stage cancer. The inventive system adds all adverse events to the user's list of symptoms in the database as the user might not be aware of the fact that an adverse event also creates a new problem to deal with.

In step 72.4, which is the last step of this sub-use case, the user is prompted to qualify the overall quality of life following this treatment and/or medical regime. This proceeds in the same way as above, with rates from 1 to 9 with 1, being very poor quality of life and 9 being very high quality of life. With this step, the process “ECOD” ends.

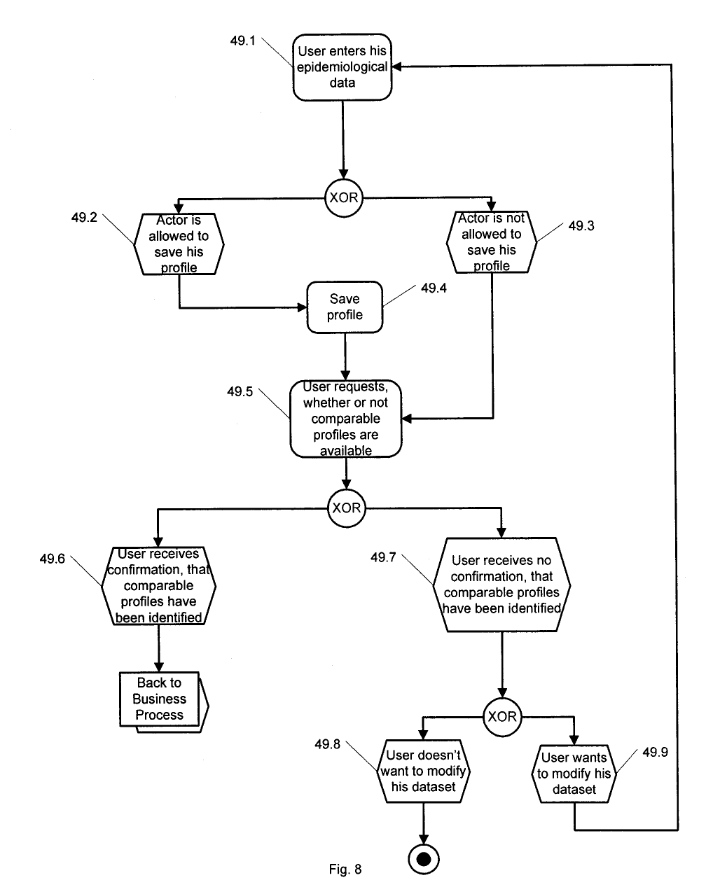

With respect to FIG. 8, the use case: “Search Matching Epidemiological Profiles” is described. First, in step 49.1, the user is prompted to enter his epidemiological data. Again, a check is made as to whether or not the user is allowed to save his profile. This distinction is necessary to differentiate between a regular user and a medical professional user again, this is analogous to step 46.2 (FIG. 6). If the user is allowed to save his profile, case 49.2, the program flow proceeds with step 49.4 where the user enters the profile data. Otherwise if the user is not allowed to save his profile, step 49.4 is by-passed (case 49.3). Then, the user clicks on the save button and saves his epidemiological profile to the system database, and the program flow proceeds with step 49.5. Otherwise if the user is not allowed to save his profile, step 49.4 is stepped over, and the user is directed immediately to the next activity 49.5. There, the user requests whether or not comparable profiles are available; (this is analogous to step 46.5). If so, the user receives confirmation that comparable profiles have been identified, case 49.6 (this is analogous to case 46.6). Otherwise, the user receives confirmation that no comparable profiles have been identified, case 49.7 (this is analogous to case 46.7). Then, if the user may want to modify his dataset case 49.9, he is directed back to step 49.1 where the process re-begins (this is analogous to case 46.9). On the other hand if the user does not want to modify his dataset, he gets the opportunity to exit the system, case 49.8.

[Sub-Use Case EEPI]

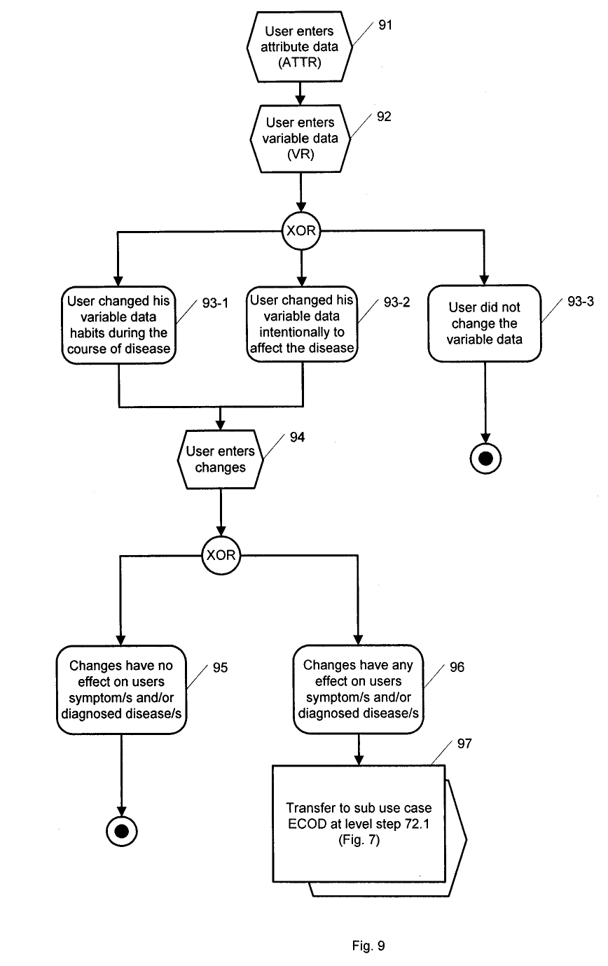

In the following, the “Enter Epidemiological Data” (EEPI) sub-use case is described with reference to FIG. 9, where the user is given the opportunity to enter epidemiological data. Also refer to Figure Table 1 “Profile Structure” describing the data structures used.

First, in step 91, the user is prompted to enter attribute data. Attribute data is data that cannot be changed during a lifetime (e.g., date of birth, hereditary diseases or the blood group). The attribute data might be used later on to find indicators for people with same attribute values for diseases commonly found in e.g. that blood group.

Then, in step 92, the user is prompted to enter variable data. Variable data is data such as body mass index, environment, and geography. The variable data pool is considered to be very powerful for the tools provided to the user community. Changes that affected the individual positively or negatively will both be monitored under the aspect of a therapy that failed or passed.

Then, in step 94, the user may enter changes he made. However, prior to entering values here the user will be asked whether he did change any of his variable data habits during the course of the disease randomly (case 93.1) or by intention (case 93.2). If neither case applies, the data he entered will be saved in the database and the partial process EEPI is over (case 93.3). Otherwise the user will enter changes in his lifestyle, diet, environment, etc.; per change he will then be asked whether this had an impact on his disease. In this way, two compartments can be added to the database: (1) Habits that affected the health positively or negatively, case 96, (2) habits that were indifferent to the health state of a patient group (e.g., started drinking red wine, scientists around the world argue back and forth whether consumption of red wine is reducing cardiovascular risk factors), case 95. If the change in lifestyle brought a difference to the health state, case 97, the user will be transferred to sub-use case ECOD at the level of 72.1 of FIG. 7. As the change in the EPI data affected the disease it is regarded as treatment and will be qualified or disqualified just like an ordinary treatment in sub-use case “enter course of disease”.

[10. Use Case: Optimize Treatment Options]

The user may come to this use case on several ways, i.e., one of interfaces 1, 2, and 3 of FIGS. 4 and 11.

The usual way to enter into this use case is illustrated in FIG. 11.

The system has now gathered all information to a person necessary to forward activities to treatment optimization. The user may want to proceed with optimizing treatment options. This is described with respect to FIG. 10. The process begins in step 10.1 where the user receives a data summary. The received data summary is in form of a chart of contents he delivered so far (in sub-use cases ECOD & EEPI). The user may have been come from step 47 (FIG. 4).

Then, the user gets the opportunity to review his data profile, see step 10.2. The user is asked whether he agrees to his profile or not. If so, case 10.3, confirmation by the user is received. If not, the program jumps to case 10.4, which will be described below. Then, the system offers to the user to optimize his treatment options, see step 10.5.2; this step is the standard way of using the system's treatment optimization tools. For this purpose, all tools are presented to the user, and the eventual benefit is explained in easy words; tool by tool can be used to learn about treatment success, adverse events, quality of life assessments, etc. of individuals or the sum of individuals from the database; refer to Table 2 below.

As an alternative, a recurring user can request an updated report, see step 10.5.1 A recurring user who has entered his profile in a previous session does not need to do that again and may request an update of the report that he saved in the previous session; in the meantime many new data points may have accumulated and complemented his optimization report. Furthermore, a user may come to step 10.5.1 directly from step 41.21 (via interface 1 of FIG. 4) as described above.

If the user wants to change his profile, step 10.4, he gets in step 10.4.1 the corresponding screens where he can modify his COD Profile, see sub-case ECOD, see FIG. 6, or to modify his EPI Profile in sub-use case EEPI, see 10.4.2, and FIG. 8.

In both alternatives, the charts desired by the user are outputted, see case 10.6. The user may save his report, step 10.7, and this business process ends at that point. Then the user may be directed back to the business process.

FIG. 11 illustrates the details of how to enter from process flow of FIG. 4 into the process flow OTO 12 illustrated in FIG. 10, via the interfaces 1, 2, 3. If the user comes via interfaces 1 or 2, the user is directed without further decision to use case OTO 12, while if coming via interface 3, the user is prompted to decide whether he wants to proceed with OTO, case 10, or to exit the system, case 11.

[Data Structures]

The data structure used in the system is described in connection with Table 1.

TABLE 1
Data Structure

| Basic elements; | | | | | | |
|---|---|---|---|---|---|---|
| they define group | | | | | | |
| of matching partners | | | | | | |
| | Sub- | Descriptive | Detail | | | Link/ |
| Category | Category | Level | Level | Example | User Interface | Environment |
| Epidemiology | Person | Female sex | Pregnancies | | Choice, number | |
| | | | Kids | | Choice, | |
| | | | | | number | |
| | | Male sex | | | | |
| | | Transgender | | | | |
| | | (female) | | | | |
| | | Transgender | | | | |
| | | (male) | | | | |
| | | Heredetary | | Diabetes | Choice, | Link content |
| | | disease | | | dynamic | & medical |
| | | (attribute) | | | | dictionary |
| | | Blood group | | AB | Choice, | |
| | | (attribute) | | | limited | |
| | | Ethnic | | | | |
| | | Background | | | | |
| | | (attribute) | | | | |
| | | Color | | Black | Choice, | |
| | | (attribute) | | | limited | |
| | | Genetic code | | | Entering Field | |
| | | Date of Birth | | | Choice, | |
| | | (attribute) | | | month&year | |
| | | Body Mass | | Bmi 170 | drop down | |
| | | Index | | | | |
| | Environment | Geography | Land & zip | USA, MN, | Choice limited | Link zip |
| | | | code | 55345 | & link zip | code |
| | | | | | code | |
| | | Environmental | Citylife | Waste | Choice, | |
| | | impact | | burning | dynamic | |
| | | | | facility | | |
| | | | Rural life | Barn | Choice, | |
| | | | | | dynamic | |
| | | Risks | Profession | Commercial | Choice, | |
| | | | | truck | dynamic | |
| | | | | rider | | |
| | | | Leisure | Sun rays | Choice, | |
| | | | | | dynamic | |
| | | Social life | Family | Isolation | | Link |
| | | | | | | calculation |
| | | | | | | biological |
| | | | | | | age |
| | Habits | food | | Fat, sugar, | Choice, | |
| | of | | | healthy | dynamic or | |
| | Living | | | | categories | |
| | | Life style | | Coffee, tea | Choice, | |
| | | consumables | | | dynamic | |
| | | Use of | | Alcohol | Choice, | |
| | | intoxicants | | | dynamic | |
| | | Sleep | | Much | Choice, | |
| | | | | | categorised | |
| | | Exercise | | Random | Choice, | |
| | | | | | categorised | |
| Course of | Diagnose | Symptoms | Emotional | Depression | | Dictionary & |
| disease | | | | | | content |
| | | | Physical | Caugh | Choice, | |
| | | | | | dynamic | |
| | | | Mental | Dementia | Choice, | |
| | | | | | dynamic | |
| | | Symptom | Association | Migrane | Choice, | |
| | | appearance | | most frequently | dynamic | |
| | | | | at | | |
| | | | | work | | |
| | | Diagnosis | Non- | Stethoscope | Choice, | |
| | | tool | invasive | | dynamic | |
| | | | Invasive | Biopsy | Choice | |
| | | | | | dynamic | |
| | | Diagnosis | | Icterus | Choice | |
| | | | | | dynamic | |
| | | Laboratory | | Eppstein | Choice | |
| | | results | | bahr | dynamic | |
| | Treatment/ | therapy T1-Tn | naturopathy | Globules | Choice | |
| | Success | | | | dynamic, | |
| | | | | | linked | |
| | | | Beauty | Suction | Choice | |
| | | | interventions | | dynamic, | |
| | | | | | linked | |
| | | | Surgery | Tumor | Choice | |
| | | | | resection | dynamic, | |
| | | | | | linked | |
| | | | Medication | ASS | Choice | |
| | | | | | dynamic, | |
| | | | | | linked | |
| | | Outcome T1-Tn | Morbidity | | | |
| | | | Mortality | Good | Scale | |
| | | Side effects/ | Emotional | Motivation | Choice | |
| | | adverse | | | dynamic | |
| | | events T1-Tn | Body | Increased | Choice | |
| | | | | sleep | dynamic | |
| | | | | demand | | |
| | | | Mental | Concentration | Choice | |
| | | | | | dynamic | |
| | | Resources | Cost | | | |
| | | T1-Tn | Time | | | |
| | | | Stay in | | | |
| | | | hospital, | | | |
| | | | lab, ambulance | | | |
| | | Quality of | | High | Scale | |
| | | Life T1-Tn | | | | |

Table 1 illustrates the guide structure for profile completion through any user. Accordingly, there are two categories (column 1) with each having three, and two subcategories, respectively (column 2). The first category is epidemiology, which has three sub-categories assigned thereto, namely person, environment, and habits of living. The second main category is cause of disease, with amnesia and treatment/success being assigned thereto as sub-categories. The categories and sub-categories are the basic elements. They define groups of (potentially) matching partners. The data acquired by the system is specified in the third column “descriptive level”. The forth, and fifth columns are explanatory to the preceding columns. Column 6 specifies the user interface through which the data is entered into the system. Column 7 is an additional link to further pertinent information. The first interaction with the system is checking symptoms and requesting a disease report as described in Process 01 “Open User Database”. Accordingly, input to the system is listed in Table 1 whereas output is listed in Table 3 below under “Product”.

In the login area, refer to use case SMDP the user will be prompted to complete his profile by checking contents that apply to his course of disease in the order of Table 1 as well as described in use case SMDP and sub-use case ECOD; all input figures represent a respective module in the database; by checking items the user is associating his course of disease with content proposed by the system; due to the fact that the database structure is known and additions are supervised and managed by Process 03 “Content Proposals”, the system is likely to be performing quickly while qualification and quantification of requested output is built in from the beginning (example: first time user enters homepage, types in symptom diarrhea, receives disease report “bacterial infection”, continues on to the register/login area and start delivering his profile according to profile structure; in one section the user will be asked about treatments that he received in order to cure his disease; for any treatment he is checking he will further be asked to name all symptoms or disease states that were treated successfully/unsuccessfully. He will then be asked to qualify success/failure with by checking a number between 1 and 9, 1 standing for true, 9 standing for false. The same qualification process is done for the quality of life or adverse events judgment. A resource tracking check box is presented in Profile Structure. Here the user quantifies cost, time and effort for various treatments.

In analogy to use case SMDP and sub-use case ECOD the user is entering his epidemiological profile in use case SMEP and sub-use case EEPI.

When the user enters the section “Optimize Treatment Options” basically any previously entered profile branch can be processed and compared with database points using manual filters. For instance, the user may ask what a treatment would cost, which adverse events does he has to face, how effective is it, etc. The structured database approach delivers valuable information, because the user receives the mean values of all opinions of previous users who left their tracks in the relevant branch of the profile structure and accordingly in the database.

The inventive system will furthermore provide standard, easy to use tools for any user. Those are displayed in Table 2 given below. They also represent filter applications, except that the user does not need to place them manually.

As an example it is assumed that most users will find it interesting to run a database report that renders all relevant profiles and reports the treatment with the best/worst patient outcome, which indicates the effectiveness of a treatment. For the other tools provided refer to Table 2. The system provides several filters for processing the medical data. These filters, along with their functions are given in Table 2 below.

TABLE 2

| Tool | Name | Target Information | Provided in |
|---|---|---|---|
| 1 | Search Diagnosis | Diagnose | Quicksearch |
| 2 | Search Treatment with | Compare any sort of treatment | Treatment optimization |
| | optimal/worst patient | with each other (house- | |
| | outcome (PO) | hold remedy, naturopathy, | |
| | | surgery, medication, . . . ) | |
| 3 | Search Treatment with | Optimal/worst quality of | Treatment optimization |
| | optimal/worst quality | life | |
| | of life (QOL) | | |
| 4 | Search Treatment with | Optimal/worst PO & QOL | Treatment optimization |
| | optimal/worst PO & | | |
| | QOL | | |
| 5 | Search Tool (automatic) | Find indicator for the presence | Treatment optimization |
| | that renders all profiles | of symptoms/diseases | |
| | and reports commonalities | | |
| 6 | Search tool that seeks | Filter application: user gets | Treatment optimization |
| | matches in the user's | the chance to compare just | |
| | profile and reports | with profiles that are closest | |
| | cases with highest/ | to his; he compares to his | |
| | lowest overlap in profile | EPI Group | |
| | structure | | |
| 7 | Search common false | Find possible false diagnosis | Treatment optimization |
| | diagnosis | to avoid wrong treatment | |
| 8 | Manual filter application | Individual filter application: | Treatment optimization |
| | | all eventual fields from the | |
| | | profile can be set as filters | |
| | | (e.g. user wants to compare | |
| | | his profile with all smokers' | |
| | | profiles | |

[Commercial Products]

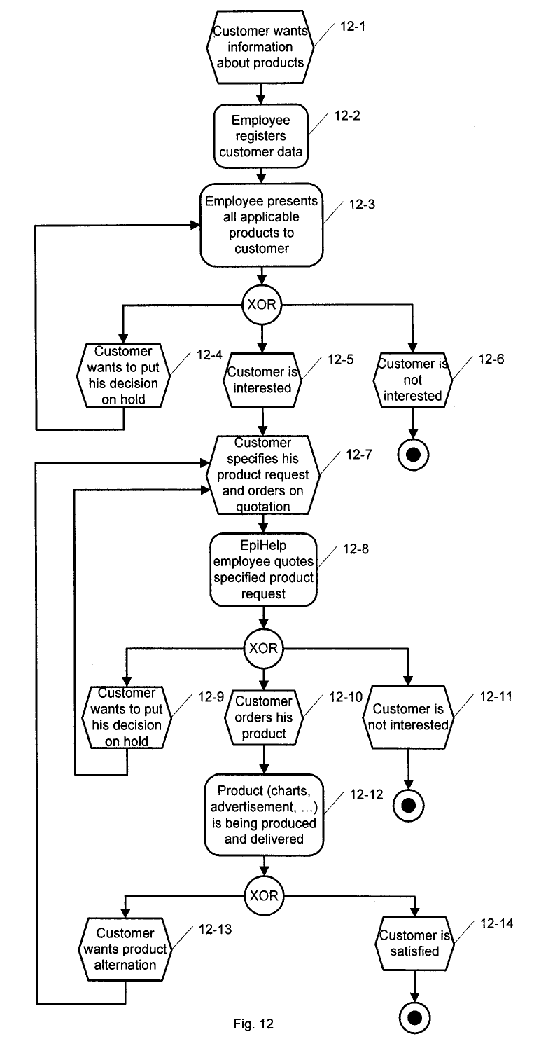

The system further supports the following commercial process. Refer also to FIG. 12, which illustrates the respective program flows.

In step 12-1 of FIG. 12, the customer is asked whether he wants information about the system or product/s. If so, a system employee registers customer data with the system, see step 12-2.

Then, a system employee presents all applicable products to customer, step 12-3. In Table 3 given below target customers and tailored product offerings of the system are given. According to potential products that can be derived from inventive system (see right column “Product”) of Table 3, the company may take on various roles:
provider of the user application which leads to treatment optimization tools (product 1, and 2);
provider of links to other sites, e.g., agents databases, medical online-dictionaries, . . . , (product 3);
advertisement placement reseller (product 4);
advertisement platform provider (product 5);
provider of corporate and institute products, e.g., for market and scientific research (product 6);
research organization, e.g., pharmaceutical industry, health carriers, (product 7);
merchandising, and affiliate links provider (product 8).

TABLE 3
Chart Structure and derived Products

| Chart Topic | Category | Subcategory | Detail Level | Criteria | Product |
|---|---|---|---|---|---|
| Chart Search Diagnosis | Diagnosis | Assumed diagnose | | % Chart with D(tv) and | Product 1: |
| (Entry Level) | | | | D(ass) | Quicksearch; |
| | | Lab verified | | % Chart with D(tv) and | Customer = User |
| | | diagnose | | D(ass) | & medical |
| | | | | | professional user |
| Chart Course | Diagnosis | Symptoms | Emotional | Positive/negativ by name | Product 2: |
| of Disease | | | Physical | Positive/negativ by name | Treatment |
| (Login Level) | | | Mental | Positive/negativ by name | Optimization; |
| | | Diagnosis tool(*) | Noninvasive | Effective/non effective | Customer = User |
| | | | Invasive | Effective/non effective | & medical |
| | | Diagnosis | | True/false | professional |
| | | Laboratory results | | True/false | user |
| | Treatment/ | Therapy | Naturopathy | Positive/negative by name | (user fees for |
| | Success | T1-Tn | Psychic | Positive/negative by name | email or |
| | | | Surgery | Positive/negative by name | CRM update |
| | | | Medication | Positive/negative by name | service) |
| | | Outcome T1-Tn | Morbidity | Best/worst Patient Outcome; | |
| | | | | staggered | |
| | | | Mortality | % of treated patients | |
| | | Side Effects/ | Emotional | Positive/negative by name | |
| | | adverse events | Body | Positive/negative by name | |
| | | T1-Tn | Mental | Positive/negative by name | |
| | | Resources T1-Tn(*) | Cost | Absolute in currency | |
| | | | Time | Absolute in hours | |
| | | | Stay in hospital, | Absolute in days | |
| | | | lab, ambulance | | |
| | | Quality of Life | | Best/worst QOL; staggered | |
| | | T1-Tn | | | |
| Chart Epidemiology | Person | Female sex(**) | Pregnancies | Male/female; number | |
| (Login Level) | | | | pregnancies/kids | |
| | | | Kids | Male/female; number | |
| | | | | pregnancies/kids | |
| | | Female transgender | | | |
| | | sex(**) | | | |
| | | Male sex(**) | | | |
| | | Male transgender | | Male/female | |
| | | sex(**) | | | |
| | | Hereditary disease | | Positive/negative by name | |
| | | Blood group(**) | | Name | |
| | | Ethnic Background(**) | | Name | |
| | | Color(**) | | Color | |
| | | Genetic code | | | |
| | | DOB(**) | | Date of birth | |
| | | BMI or size and | | Absolute number | |
| | | weight | | | |
| | Environment | Geography | Country & zip | Country | |
| | | | code | | |
| | | Environmental | City life | Name | |
| | | impact | Rural life | Name | |
| | | Risks | Profession | name | |
| | | | Leisure | name | |
| | | Social life | family | Description | |
| | Habits of | Food | | Name/description | |
| | living | Use of intoxicants | | Name | |
| | | Sleep | | Hours | |
| | | Exercise | | times per week | |
| Info/Help | Product links | Online medical | | | Product 3: |
| Tool | | dictionary | | | links to other |
| | | Active agent | | | providers |
| | | database | | | |
| Number of | Disease categories | Overall number | | | Product 4: |
| users | | of specific cases | | | advertisement |
| | | Frequency of | | | placement |
| | | specific cases | | | |
| Forum/Blog | Disease categories | Overall number | | | Product 5: |
| | | of specific cases | | | advertisement |
| | | Frequency of | | | platforms |
| | | specific cases | | | |
| Charts consulting | Database | All runs from | | | Product 6: |
| for | reports | EPI & COD | | | corporate and |
| Pharma, Industry | | Trends | Popularity of active | | institute products |
| & Institutes | | | agent | | (market & |
| | | | Quality of life | | scientific |
| | | | citations | | research) |
| | | | Popularity of treament | | |
| | | | forms (naturopathy, | | |
| | | | surgery. etc.) | | |
| | | Active agents | Risk assessment of | | |
| | | | new active agents | | |
| | | | Track resistencies | | |
| | | | and efficacy in | | |
| | | | early stages | | |
| | | Safety and efficacy | Indicators for a | | |
| | | | successful clinical | | |
| | | | study design | | |
| | | | adverse events can | | |
| | | | be calculated and | | |
| | | | treatment success | | |
| | | | can be evaluated, | | |
| | | | good decision tool | | |
| | | | for investment in | | |
| | | | new technologies | | |
| Chart Health | Database | All runs from | | | Product 7: |
| Care Carriers(*) | reports | COD & EPI | | | Research for |
| | | Cost efficacy | | | carriers |
| | | through efficient | | | (market & |
| | | treatment recommendation | | | scientific |
| | | | | | research) |
| Integrated | Disease categories | Overall number | | | Product 8: |
| Online Shops | | of specific cases | | | Merchandising, |
| | | Frequency of | | | direct sales, |
| | | specific cases | | | affiliate links |

Glossary:
Mode of Death (MOD) = complication that started the disease state;
Cause of Death (CAUOD) = Complication that leads to death;
D(tv) = Disease test verified;
D(ass) = Disease assumed;
QOL = Quality of Life;
DOB = Date of Birth;
BMI = Body Mass Index
(*)these applications are restricted for medical professional user
(**)these attributes are not affected by any changes throughout a lifetime
supporting methodologies: instead of listing all cases of one year we might list (e.g. 300 cases in a row, in order to avoid traceability (if necessary for privacy reasons))

It is also an option that a customer receives automated update on product offerings in form of email or direct data delivery into his Customer Relation Management (CRM) system; it may e.g. be of interest to place directed advertisement as soon as a certain amount of users are registered overall or in a specific category (e.g. place ads as soon as 5000 migraine patients are registered).

If the customer is interested in the system product (case 12-5), the customer specifies his product request and requests a quotation from the system, step 12-7. Then, the system employee quotes specified product request, see step 12-8. Otherwise, if the user wants to put his decision as to ordering the product on hold (case 12-4), the process flow loops back to step 12-7, of if the user is not interested at all (case 12-6), the process ends at that point.

Then, the customer may order the product, case 12-10. The system employee/s produce(s), deliver(s) and charge(s) the product, step 12-12, and will be satisfied, step 12-14, or alter the product, step 12-13. In the latter case, the program leads the user back to step 12-7.

If, on the other hand, the user does not want to order the product, the program flow terminates at that point, case 12-11, or if the user wishes to put his decision on hold, the program flow branches to case 12-9.

Case 12-13. Customer wants product alternation; this customer will have the chance to specify his product request to his enhanced requirements. Case 12-14: Customer is satisfied; the process flow ends at that point.

The present techniques can be implemented in digital electronic circuitry, or in computer hardware, firmware, software, or in combinations of them. Apparatus of the invention can be implemented in a computer program product tangibly embodied in a machine-readable storage device for execution by a programmable processor. Method steps according to the invention can be performed by a programmable processor executing a program of instructions to perform functions of the invention by operating on the basis of input data, and by generating output data. The invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories, in particular from read-only memories and/or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in ASICs (application-specific integrated circuits).

The computer systems or distributed computer networks as mentioned above may be used, for example, for producing goods, delivering parts for assembling products, controlling technical or economical processes, or implementing telecommunication activities.

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g. an RF communication link). A display is coupled to an interface, which is coupled to an I/O bus. A keyboard and pointing device are also coupled to the I/O bus. Alternatively, separate buses may be used for the keyboard pointing device and I/O interface.

1. A computer-implemented method of processing medical data of a database, the medical data relating to diseases, and symptoms related to the diseases, said method including:
A) Requesting an individual user to input data descriptive of a symptom;
B) Searching the database for data descriptive of diseases related to the inputted data descriptive of the symptom;
C) Generating a report listing diseases which are related to the inputted data descriptive of the symptom;
D) Associating a frequency indication to the each of the listed diseases, the frequency indication being representative of the frequency of reported associations of the respective listed disease;
E) Outputting the report with the frequency indication associated with each of the listed diseases.

2. A computer-implemented method of collecting medical data for a database, the medical data relating to symptoms, diseases, and treatments of individual users with respect to diseases, said method including:
A) Requesting an individual user to input data descriptive of symptoms of a disease;
B) Requesting individual user to input data descriptive of a diagnosis made by a medical professional with respect to the symptoms and the individual user;
C) Requesting individual user to input data descriptive of a treatment received by the individual user with respect to the symptoms and the diagnosis;
D) Requesting individual user to input data descriptive of symptoms and diagnosed disease which has been successfully treated;
E) Requesting individual user to input data descriptive of symptoms and diagnosed disease which has not been successfully treated;
F) Requesting input of qualification of the treatment received;
G) storing the inputted data;
H) Requesting individual user to input data descriptive of resources for the treatment received, the resources comprising at least one of:
quantities of treatment;
cost of treatment;
time of treatment; and
human resource factor

3. The method of claim 1, further comprising:
Associating time information with the data inputted by the user.

4. A computer-implemented method of collecting medical data for a database, the medical data relating to diseases, symptoms and treatments of individual users, said method including:
A) Requesting individual user to input attribute data for an individual user, the attribute data being data which is constant during lifetime of the individual user; attribute data comprising at least one of
date of birth;
blood group;
genetic code;
indications as to ethnic background;
indications as to hereditary diseases;
B) Requesting individual user to input variable data for an individual user, the variable data being data which is subject to changes during lifetime of the individual user; variable data comprising at least one of
body mass index;
indications as to geographic location;
indications as to environment;
indications as to risks;
C) Associating the inputted data with the individual user;
D) Storing the inputted data associated with the individual user in the database.

5. The method of claim 4, further comprising:
associating a new user profile with the stored inputted data.

6. The method of claim 5, further comprising:
Displaying the new user profile to the individual user for review;
Requesting the user to input data.

7. The method of claim 6, further comprising:
Presenting a plurality of optimization tools to the individual user, each tool providing data processing operations which comprise at least one of:
searching diagnosis;
searching treatment with optimal outcome;
searching treatment with worst outcome;
searching treatment with optimal quality of life;
searching treatment with worst quality of life;
search matches in user profile and cases with highest overlaps in profile structure;
search common false diagnosis;
filtering according to user specified criteria;
rendering all database profiles of one symptom/disease category and report commonalities in their treatment- or epidemiological pattern.

8. The method of claim 7, further comprising:
Presenting a set of resource tracking tools, the research tracking tools providing at least one of:
quantities of treatment;
cost of treatment;
time of treatment; and
human resource factor.

9. The method of claim 8, further comprising:
Presentation as a function of user (qualification group).

10. The method of claim 9, further comprising:
Providing the tools via internet.

11. The method of claim 10, further comprising:
Providing the tools on portable devices.

12. A computer-implemented method of collecting medical data for a database, the medical data relating to diseases, symptoms and treatments of individual users, said method including:
A) Displaying, to an individual user, text fields comprising data descriptive of predefined symptoms of predetermined diseases;
B) Prompting the individual user to select one of the text fields;
C) If the individual user does not select any of the text fields, prompting the individual user to enter the data descriptive of the particular symptom in a free text field;
D) Performing a search in the database for data similar to the data inputted in the free text field;
E) If data similar to the inputted data is found in the database, discarding the inputted data;
F) If data similar to the inputted data is not found in the database, initiating an evaluation process of the inputted data.

13. The method of claim 12, wherein the evaluation process comprises:
forwarding inputted data to predetermined specialists for evaluation;
receiving evaluation results from predetermined specialists.

14. The method of claim 13, wherein if the evaluation results are positive, new text fields are created which comprise inputted data descriptive of the disease.

15. The method of claim 14, further comprising:
Notifying the individual user about evaluation results of specialists.

16. The method of claim 1, further comprising:
Providing, to a user, access to the database via an internet platform.

17. The method of claim 1, further comprising:
Providing, to a user, access to the database via an internet platform.

18. The method of claim 1, further comprising:
Billing the access to the database.

19. The method of claim 1, further comprising:
Providing, via the internet platform, a predetermined number of commercial products or lo services.

20. A computer-readable storage medium comprising program code for performing the method according to claim 1, when loaded into a computer system.
